(19) United States
(12) Patent Application Publication
(10) Pub. No.: US 2020/0139654 A1
(43) Pub. Date: May 7, 2020

(54) METHOD FOR MANUFACTURING AN INFLATABLE LIFTING CUSHION AND LIFTING CUSHION

(71) Applicant: Vetter GmbH, Zülpich (DE)

(72) Inventors: Carsten SAUERBIER, Lauf (DE); Wilhelm SCHNICKE, Bad Münstereifel (DE)

(73) Assignee: Vetter GmbH, Zülpich (DE)

(21) Appl. No.: 16/624,168

(22) PCT Filed: Jun. 19, 2017
(86) PCT No.: PCT/EP2017/064936

§ 371 Date: Dec. 18, 2019

(51) Int. Cl. B29D 22/02; B32B 25/10; B66F 3/35

(52) U.S. Cl. CPC B29D 22/02; A62B 3/005; B66F 3/35; B32B 25/10

(57) ABSTRACT

A method for producing an inflatable lifting cushion includes providing a core with main surfaces in the form of a front side and a rear side and an outer peripheral region. A two-dimensional layer of vulcanizable material is applied on the front side and rear side of the core. A single-layer or multi-layer prefabricated two-dimensional fiber-reinforcing layer is drawn in the form of a tube, onto the arrangement including the core and two-dimensional layers of vulcanizable material located on the core so that the fiber-reinforcing layer, extending around the peripheral region, covers the two-dimensional layers of vulcanizable material at least partially. A further two-dimensional layer of vulcanizable material is applied to the fiber-reinforcing layer at the front side and the rear side of the core. The arrangement is heated to obtain a bond of the fibers of the fiber-reinforcing layer with the two-dimensional layers of the vulcanizable material.

The present invention relates to a method for producing an inflatable lifting cushion and a lifting cushion.

### TECHNOLOGICAL BACKGROUND

Lifting cushions (also called lift cushions, compressed air cushions, pressure cushions or pneumatic lifting sets) are devices that can be inflated with compressed air and used to lift loads. For example, lifting cushions can be used as lifting equipment in rescue and disaster relief. For example, people can be freed using lifting cushions in the event of earthquakes. In addition, lifting cushions can be used to lift loads such as vehicles or aircraft during maintenance or repair work.

In most cases, lifting cushions are flat in the initial state, i.e. in the state before filling with compressed air, on the one hand so that the lifting cushions can be inserted into small gaps and on the other hand to allow for simplified storage of the lifting cushions. Lifting cushions are usually made of vulcanizable material (e.g. rubber). Using compressed air, the lifting cushions are inflated. In this case, the material expands in a predetermined direction by design, e.g. upward, and thus performs the necessary lifting work. Lifting cushions are usually operated with a pressure of up to 12 bar. Normative regulations require a safety factor of 4, so that lifting cushions must withstand a pressure of 48 bar without damage. Since none of the vulcanizable materials used are able to bear the high incident stresses by themselves, fabrics are incorporated into the material for reinforcement. These fabrics are embedded in a matrix of vulcanizable material so that there is sufficient flexibility to follow the change in shape of the lifting cushion during operation.

As a rule, the aforementioned requirements make it necessary for considerably more material to be applied than would be necessary from a purely mechanical point of view. On the one hand, this makes the lifting cushions particularly heavy, and on the other hand it increases the cost of material and processing times.

### PRINTED PRIOR ART

U.S. Pat. No. 5,938,179 discloses a method for producing a lifting cushion, in which first a layer of vulcanizable material is sprayed onto a rotationally-symmetrical molding core connected to a rotatable mandrel, the core being made of bonded sand particles. Further, a fiber layer is applied thereon by pulling a rubber-impregnated fiber from a roll and continuously winding it onto the molding core. Subsequently, an outer protective layer is applied, and the molding core is destroyed and removed. The process is complicated and expensive.

A similar process is known from EP 0 626 338 B1. In this case, continuous fibers are geodesically wound around a rotationally-symmetrical body. Subsequently, an elastomer is vulcanized onto the fibers. Alternatively, elastomer-impregnated fibers may also be wound to form the elastomer matrix. After the fiber reinforcement has been wrapped around the core, the core is removed.

EP 2 332 879 B1 discloses a lifting cushion made of a rubber material vulcanized in a press and previously in the form of a sheet, the material having an internal bladder and a shell of reinforced rubber material located outside the bladder and closely surrounding it. To produce this lifting cushion, the bladder is first made in a first vulcanizing step. The shell is then made in a second vulcanizing step, with a release agent between the shell and the bladder so that the shell is not bonded to the bladder.

### OBJECT OF THE PRESENT INVENTION

The object of the present invention is to provide a novel method for producing an inflatable lifting cushion, the method enabling the production of a lifting cushion with improved mechanical stress characteristics in a simple and cost-effective manner. The object of the present invention is also to provide a corresponding lifting cushion.

### Solution of the Object

The above object is solved by the features of claim 1 and of claim 14. Advantageous embodiments are claimed in the dependent claims.

According to the invention, a core is first provided which has main surfaces in the form of a front and rear side and an outer peripheral region. Then, one two-dimensional layer each, i.e. a disc made of (non fiber-reinforced) vulcanizable material or elastomer, is disposed on the front and back of the core and held there in position. Here, the two-dimensional layers can touch one another in the outer peripheral region and/or can be covered there on the outside by an additional strip layer. Then, a single- or multilayer, prefabricated two-dimensional fiber-reinforcing layer is pulled over the entire arrangement of the core and layers of vulcanizable material positioned thereon such that the fiber-reinforcing layer passes around the peripheral region and at least partially, preferably completely, covers the two-dimensional layers of vulcanizable material. Thereafter, a further two-dimensional layer, i.e. a disc made of (non-reinforced) vulcanizable material or elastomer, is applied to the outside of the fiber-reinforcing layer or arrangement in the region of the front and back side of the core. The fiber-reinforcing layer is thus embedded in sandwiched fashion in an inner and outer layer of vulcanizable material or elastomer. As a result, an optimal embedding of fiber-reinforcing layer is achieved in the vulcanizable material. In a simple manner, a sufficiently stable fiber reinforcement made of continuous fibers is applied to the outside of the vulcanizable material, which ensures uniform coverage of the vulcanizable material with continuous fibers and also and especially encloses the peripheral region with continuous fibers, which is an enormous advantage regarding the mechanical stress point of view. Finally, the arrangement is heated or hot vulcanized in such a way that a matrix composite of the fibers of the fiber-reinforcing layer and the two-dimensional layers of vulcanizable material is established. An elaborate winding of continuous fiber in a certain winding geometry including the necessary apparatus design is no longer necessary. The method according to the invention therefore provides a considerable savings effect. In the case of changes in dimensions, the method according to the invention can be changed over particularly easily, i.e. it can be adapted to production requirements. In addition, due to the new production method, there are no mechanical stress “problem areas” that would have to be remedied by an increased use of fiber windings and/or fiber-reinforced material. The lifting cushion produced by the method according to the invention is characterized by a comparatively low weight and is therefore very easy to handle. The two-dimensional layers of vulcanizable material can be single-layered or in turn can themselves comprise a plurality of layers.

Expediently, a tube or a tubular structure is used as a single-layered or multi-layered, prefabricated two-dimensional fiber-reinforcing layer which can be pulled over the arrangement of the core and the two-dimensional layers of vulcanizable material located thereon like a stocking. In this case, the above-mentioned arrangement is disposed transverse relative to the longitudinal extent of the stocking so that after the stocking is pulled on or in the case of a continuous tube after cutting off the necessary length of the fiber-reinforcing layer, the open tubular ends of the fiber-reinforcing layer are respectively beaten inward onto the front or back side of the core. The application of the fiber-reinforcing layer is particularly fast and effective. On the other hand, this method ensures a continuous fiber reinforcement around the entire circumference, without any point of separation.

Advantageously, the tubular fiber-reinforcing layer can be stretchable in diameter, so that the fiber-reinforcing layer essentially automatically sits against the front and rear side of the arrangement of the core and the two-dimensional layers disposed thereon around said arrangement or at least a part thereof.

Conveniently, the prefabricated fiber-reinforcing layer is a woven or knitted fabric.

Preferably, the fibers of the prefabricated fiber-reinforcing layer are continuous from one end to the other end of the fiber-reinforcing layer.

Because the two-dimensional layer of vulcanizable material need not have any fiber reinforcement, rubber parts, for example in the form of cut-out or punched rubber mats, can be used in a simple manner for this purpose.

In particular, the two-dimensional layer of vulcanized material may preferably, at least substantially, also have a round shape, i.e. may be used in a round disk shape. Equally well, a rectangular disc shape can be used.

In order to justify a matrix composite also in the outer peripheral region, the two-dimensional layers are dimensioned such that they touch in the outer peripheral region or at least can be brought into contact there.

Alternatively or additionally, an additional strip running along the circumference of the peripheral region, which likewise consists of vulcanizable material or elastomer, can be placed or arranged in the outer peripheral region of the two-dimensional layers. The strip covers the peripheral region of the two-dimensional layers and is also covered on the outside thereof by the fiber-reinforcing layer.

The peripheral region of the core is designed tapered in cross-section. This facilitates the merging of the two-dimensional layers in the outer peripheral region. Preferably, the core has a lens-like shape. Alternatively, viewed in cross-section, the core may also have a round, ellipsoidal or even rectangular basic shape or a combination thereof, which makes it possible to produce lifting cushions of an appropriate shape as required and depending on the intended use.

Conveniently, the core consists of a material which is removed after vulcanization or heating. In particular, the core is a material which can be washed out or rinsed out with liquid, for example chalk. Advantageously, in this process step this material can be flushed out during the final inspection of the lifting cushion in which water is usually injected into the lifting cushion for pressure testing purposes. Also useful would be a core made of material which is soluble in a liquid, for example water, or a heat-shrinkable material such as Styrofoam, or a material which is bonded to a heat-sensitive adhesive or a combination of a plurality of the aforementioned options.

If a lifting cushion with so-called pole caps is desired, a pole cap can be attached to the front side and/or to the back side of the core according to the method according to the invention before applying the two-dimensional layers. In this case, the two-dimensional layers of vulcanizable material are provided with cut-outs corresponding to the size of the pole caps. With regard to the fiber-reinforcing layer, which has a circumferential end region in particular in the case of tubular form, this is of very particular advantage since this circumferential end region can advantageously cling to the pole cap.

Preferably, the fiber-reinforcing layer or its annular end region is to be designed such that the layer or the end region thereof reaches the pole cap or is taken up by the pole cap. As a result, an advantageous reinforcement effect is ensured even in the transition region from the lifting cushion material to the pole cap.

The present invention also relates, secondarily, to an inflatable lifting cushion according to claim 16. The lifting cushion according to the invention has the advantage that on the one hand it is very simple and inexpensive to produce, and on the other hand has very good mechanical stress properties. In addition, the lifting cushion according to the invention is characterized by a comparatively low weight and is consequently very easy to handle.

The good mechanical stress properties of the lifting cushion according to the invention also result from the fact that the fibers of the two-dimensional fiber-reinforcing layer extend around the peripheral region and into the front and back sides of the lifting cushion, respectively, in an uninterrupted continuous arrangement along the outer peripheral region of the lifting cushion.

The fiber-reinforcing layer can form overlapping areas on the front and/or back side, whereby the total weight of the lifting cushion is not adversely affected and also the mechanical stress properties suffer no disadvantage from this.

Alternatively, if the fiber-reinforcing layer has sufficient flexibility, the respective cut-off end portion may terminate in the central region of the front and back side of the lifting cushion, respectively. This is possible because the fiber ends according to the invention are located in this area and the fiber end pieces have the least detrimental effect there from a mechanical stress point of view.

An expedient embodiment of the lifting cushion according to the invention has a two-dimensional layer, such as a disc, made of vulcanizable material or elastomer on both the inside of the fiber-reinforcing layer and on the outside thereof. The lifting cushion may preferably have a round or rectangular shape. Both shapes can be produced in a simple manner with the method according to the invention.

Preferably, a pole cap is provided on the front and/or back side of the inflatable lift bag, the fiber-reinforcing layer having a preferably annular end portion which extends toward or is received by the pole caps.

Due to the fact that the pole cap has a receptacle or step which receives the respective end regions of the two-dimensional layer and/or the fiber-reinforcing layer, a particularly intimate mechanical connection is achieved between the pole cap and the inflatable lifting cushion.

### DESCRIPTION OF THE INVENTION ON THE BASIS OF EXEMPLARY EMBODIMENTS

Advantageous embodiments of the method and lifting cushion according to the invention are explained below with reference to the drawing figures. The figures show the following:

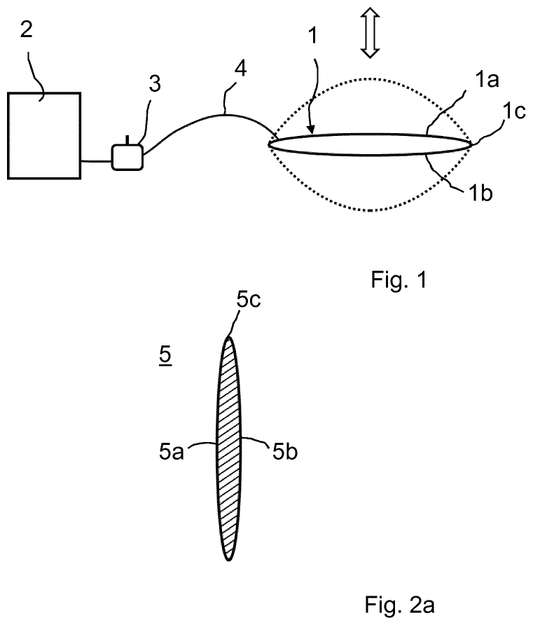

FIG. 1 a highly simplified schematic representation of an arrangement with a lifting cushion for lifting heavy loads;

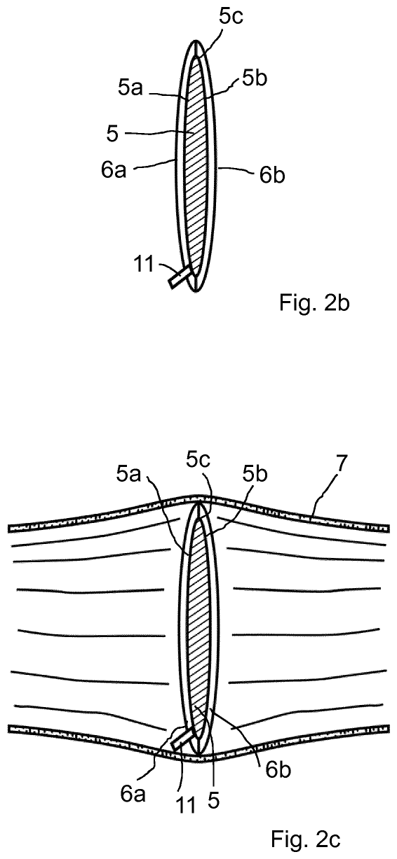

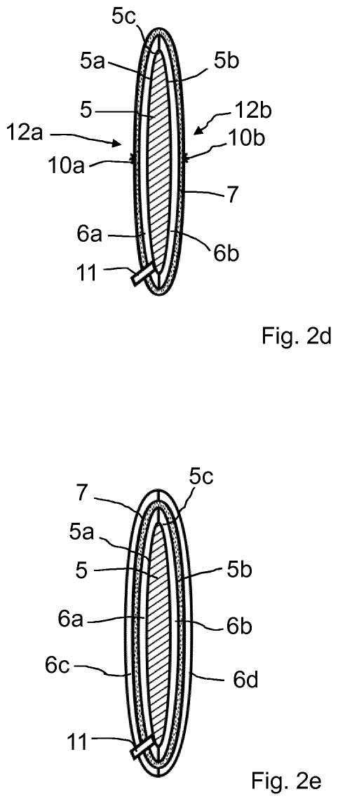

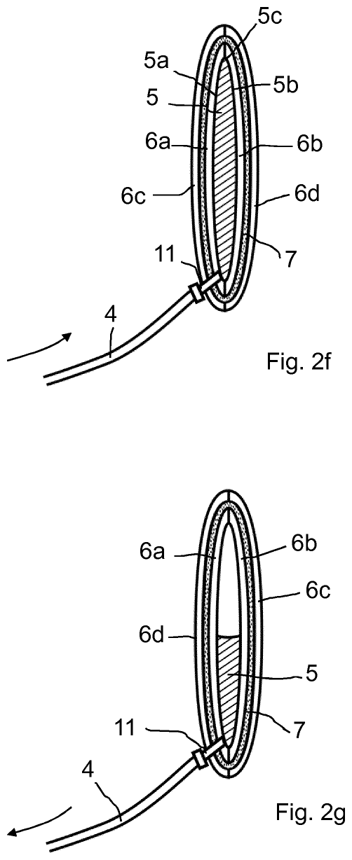

FIG. 2 different stages of a first embodiment of the method according to the invention for producing a lifting cushion;

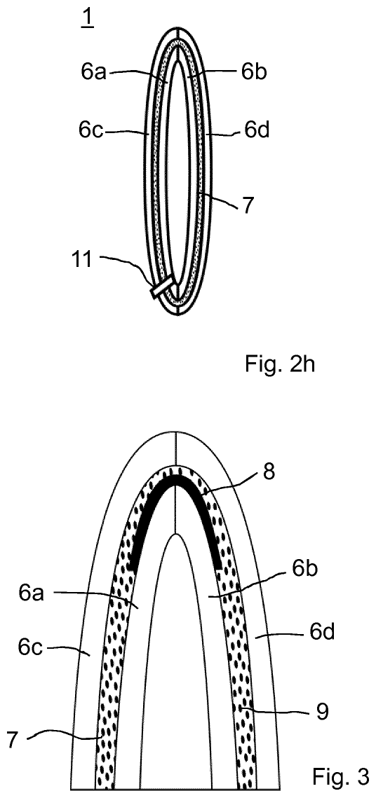

FIG. 3 a partial sectional view of a lifting cushion according to another embodiment of the present invention;

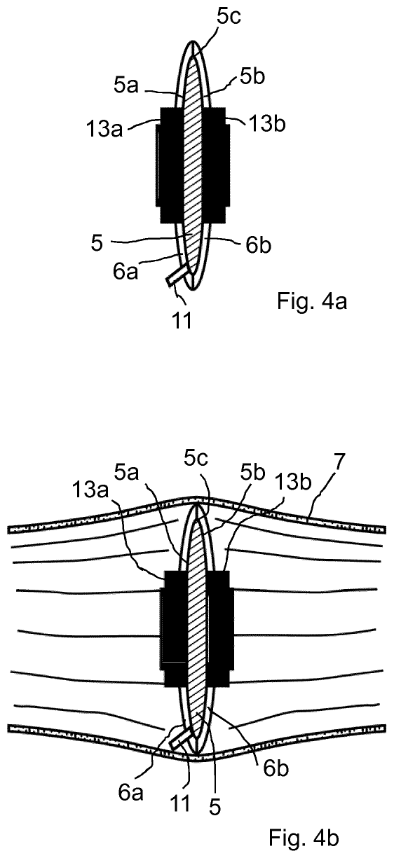

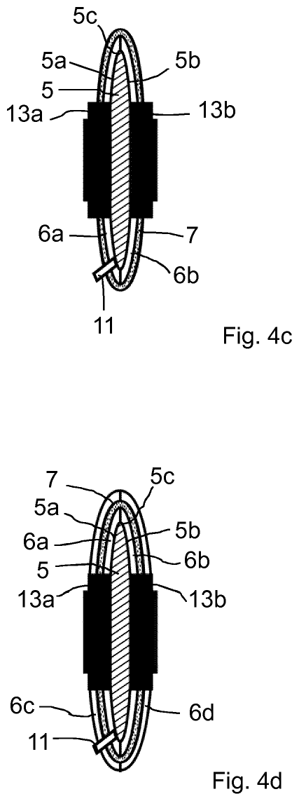

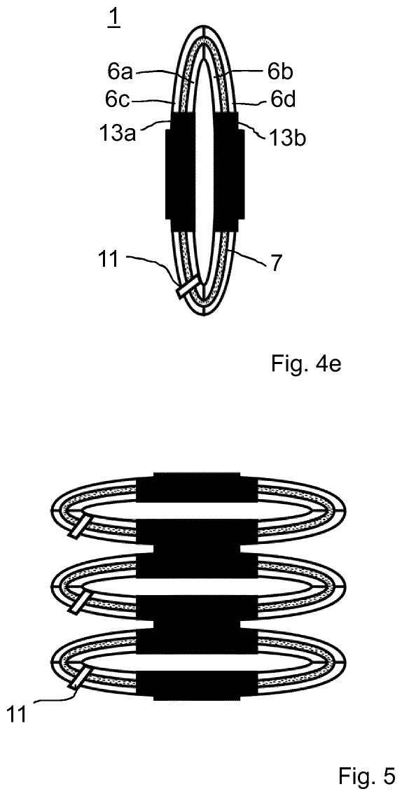

FIG. 4 different stages of a second embodiment of the method according to the invention for producing a lifting cushion;

FIG. 5 a highly simplified schematic representation of the arrangement of a plurality of interconnected lifting cushions; and

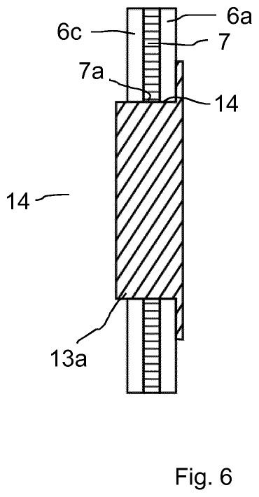

FIG. 6 an enlarged sectional view of the area of a pole cap of a lifting cushion according to the invention.

Reference numeral 1 in FIG. 1 denotes a lifting cushion for lifting heavy loads. The lifting cushion has a flattened shape in the unpressurized state. This shape makes it possible for the lifting cushion to be inserted into narrow gaps during use. Such lifting cushions are intended for a wide variety of applications. For example, lifting cushions can be used to lift vehicles or aircraft in accidents, to raise collapsed walls or ceilings during earthquakes. In addition, lifting cushions can also be used as assembly aids or maintenance/repair aids in a wide variety of areas. The lifting cushion 1 is here used with its top 1a and bottom 1b placed in a gap between the base and the load to be lifted. The loading direction therefore essentially corresponds to the orientation of the arrow shown in FIG. 1.

The filling of the lifting cushion 1 is usually carried out with compressed air, which is generated via a compressed air source 2, for example a compressed air cylinder, and is supplied via a hose 4 to the lifting cushion 1. Between the lifting cushion 1 and the compressed air source 2 is a control valve 3, by means of which the operator can control the lifting of the lifting cushion. In the inflated, unloaded state, the lifting cushion has approximately the shape shown by the dotted outline.

The manufacture of the inventive, for example lenticular lifting cushion 1, will be described in more detail below. First, a core 5 is provided, which when viewed in cross-section, has approximately a lenticular basic shape, for example. The core 5 comprises a front side 5a, a back side 5b and a circumferential peripheral region 5c which approximately correspond in orientation to the front side 1a, the bottom side 1b and the peripheral region 1c of the lifting cushion 1 from FIG. 1.

The core 5 consists of a solid material, such as chalk, which can be removed from the lifting cushion 1 after the production thereof. After provision of the core 5, as shown in FIG. 2b, a respective two-dimensional layer 6a and 6b of a vulcanizable material or an elastomer is disposed both on the front side 5a and on the back side 5b and held in position. The layers 6a, 6b touch each other in the outer peripheral region 5c of the core 5. Preferably, the layers 6a, 6b are rubber discs, in particular discs which have no fabric reinforcement. The positioning of the two two-dimensional layers 6a, 6b can be accomplished by suitable devices. Furthermore, in the context of this process step, a valve can be used 11, which serves to establish a connection with a hose line of a compressed air source in order to fill the lifting cushion. Accordingly, the valve 11 or a corresponding valve insert is positioned in an opening of the layer 6a, for example.

According to FIG. 2c, the arrangement of FIG. 2b is subsequently covered with a single-layer or multi-layer, prefabricated two-dimensional fiber-reinforcing layer 7, preferably in the form of a fiber-reinforcing tube, in such a way that the arrangement consisting of core 5 and layers 6a, 6b is positioned essentially transverse relative to the longitudinal orientation of the tube and extends lateral to the arrangement at approximately equal lengths.

Subsequently, the free ends of the fiber-reinforcing tube must be pushed inwards and form joints 10a, 10b approximately in the central region of the front and back sides 5a, 5b of the core 5 joints. The fiber-reinforcing tube may alternatively have a flexibility that causes the protruding areas to more or less automatically sit against the front or back side of the arrangement or at least against a part thereof. In any case, the arrangement according to FIG. 2c forms a fiber reinforcement with fibers which extend from one end of the tube over the respective peripheral region of the arrangement to the other end of the tube, and indeed fully-circumferential to the core 5.

After the ends of the fiber-reinforcing tube are pushed in, the fibers end at these joints 10a, 10b as shown in FIG. 2d, so that either overlapping regions 12a, 12b of the fiber-reinforcing can be provided or else the fibers can also abut each other or can lie radially relative to each other depending on the starting material of the fiber reinforcement 7.

Thereafter, according to FIG. 2e, a further layer 6c, 6d of vulcanizable material or elastomer is applied both on the front side and on the back side. Consequently, the arrangement shown in FIG. 2e forms a sandwich-like layer sequence of core 5, two-dimensional layer 6a, fiber-reinforcing layer 7, two-dimensional layer 6c on the side shown on the left in FIG. 2e. The two-dimensional layer 6c also has an opening (not shown in FIG. 2e) for the valve 11.

The arrangement is now subjected to a hot vulcanization step in which the vulcanizable material of the layers 6a, 6b, 6c, 6d is liquefied and forms an intimate elastomer/fiber matrix with the fibers of the fiber-reinforcing layer 7. The layers 6a, 6b, 6c, 6d thus lose their interfaces and form a uniform layer of elastomer in which the fibers are embedded.

After cooling the assembly, the hose 4 is connected via the valve 11 and the core 5 is flushed out by means of water, for example. The core 5 dissolves gradually, as indicated in FIG. 2g. The finished lifting cushion is shown in FIG. 2h. It has a flattened shape and is characterized by optimal mechanical stress characteristics.

According to an alternative embodiment of the present invention shown in FIG. 3, an additional strip 8 of elastomeric material or elastomer can be laid around or provided in the peripheral region 1a of the lifting cushion 1, the fiber-reinforcing layer 7 being located on the outside of said material or elastomer prior to vulcanization.

The present invention is particularly suitable for the production of lifting cushions with so-called pole caps. In applications involving bridging larger distances, such lifting cushions can be connected at the respective pole caps and thereby be stacked and pumped individually in the stack. Adjacent stacked lifting cushions are locked to each other via their pole caps. The pole caps have a locking mechanism for this purpose. The pole caps are used for positioning and mechanical fixation of the lifting cushions to each other, so that a reproducible lifting operation can also be carried out using stacked lifting cushions.

For this purpose, after provision of the core 5, pole caps 13a and 13b, for example made of steel, are positioned preferably on both sides, on the front 5a and rear side 5b of the core 5, and then the two two-dimensional layers 6a, 6b are placed or applied as shown in FIG. 4a. For this purpose, the two-dimensional layers 6a, 6b must have a recess corresponding to the pole cap.

Subsequently, according to the invention, the two-dimensional fiber-reinforcing layer 7, as in the case of the method described under FIG. 2c, is applied to the arrangement. The fiber-reinforcing layer 7 here already has the required length or is then cut to length accordingly. The open end regions are then pulled inwardly so that the end regions of the fiber-reinforcing layer 7 extend up to the respective pole cap 13a, 13b, as shown in FIG. 4c.

Subsequently, according to FIG. 4d, a further two-dimensional layer 6c and 6d is applied to the front and rear side 5a and 5b of the core 5 and the overall arrangement, as shown in FIG. 4d, is subjected to a vulcanization process. After vulcanization, the core is removed in the manner already described in FIG. 2g. For the sake of simplicity, therefore, reference will be made to this.

As a final result, a lifting cushion as shown in FIG. 4e is provided, which ensures the possibility of stacking, as shown in a greatly simplified representation in FIG. 5.

The pole cap 13a, 13b can, as shown enlarged in the arrangement of FIG. 6, preferably have a receptacle 14 or step into which the two-dimensional layers 6a, 6c and the annular end region 7a of the fiber-reinforcing layer 7 are accommodated.

The tubular fiber-reinforcing layer 7 may in particular be one that is stretchable in diameter. The fiber-reinforcing layer 7 may be one or more layers.

Furthermore, the prefabricated fiber-reinforcing layer 7 may be a woven fabric or a knitted fabric.

The lifting cushion can have a round or rectangular shape.

### LIST OF REFERENCE SIGNS

1 lifting cushion
1a top side
1b bottom side
1c peripheral region
2 compressed air source
3 control valve
4 hose line
5 core
5a front side
5b back side
5c peripheral region
6a two-dimensional layer
6b two-dimensional layer
6c two-dimensional layer
6d two-dimensional layer
7 fiber reinforcement
7a annular end region
8 strips
9 fiber
10a joint
10b joint
11 valve
12a overlap area
12b overlap area
13a pole cap
13b pole cap
14 receptacle

1. A method for producing an inflatable lifting cushion comprising:
providing a core with main surfaces comprising a front side and a rear side and an outer peripheral region,
applying a two-dimensional layer of vulcanizable material on the front side and the rear side of the core,
pulling a single-layer or multilayer prefabricated two-dimensional fiber-reinforcing layer onto the arrangement comprising the core and two-dimensional layers of vulcanizable material located thereon so that the fiber-reinforcing layer, extending around the peripheral region, covers the two-dimensional layers of vulcanizable material at least partially,
applying a further two-dimensional layer of vulcanizable material to the fiber-reinforcing layer in the region of the front side and the rear side of the core; and
heating the arrangement so that a bonding of the fibers of the fiber-reinforcing layer with the two-dimensional layers of vulcanizable material is obtained, wherein
as a single-layer or multi-layer prefabricated two-dimensional fiber-reinforcing layer, a tubular structure is pulled over the arrangement of the core and the two-dimensional layers of vulcanizable material located thereon like a stocking.

2. The method of claim 1, wherein a continuous tube is used as a single-layer or multi-layer prefabricated fiber-reinforcing layer, and after cutting off of a necessary length, open tubular ends of the fiber-reinforcing layer are respectively beaten inward onto the front side and back side of the core.

3. The method according to claim 1, wherein the tubular structure or the continuous tube is stretchable in diameter.

4. The method according to claim 1, wherein the pre-fabricated fiber-reinforcing layer is a fabric or a knitted fabric.

5. The method according to claim 1, wherein the two-dimensional layer of vulcanizable material is free of fiber reinforcement.

6. The method according to claim 1, wherein the two-dimensional layer of vulcanizable material has an at least substantially round shape.

7. The method according to claim 1, wherein the two-dimensional layer of vulcanizable material has an at least substantially rectangular shape.

8. The method according to claim 1, wherein the two-dimensional layers touch in the outer peripheral region or at least can be brought into contact.

9. The method according to claim 1, wherein an additional strip of vulcanizable material is provided in the outer peripheral region of the two-dimensional layers running along a circumference around the peripheral region.

10. The method according to claim 1, wherein viewed in cross-section, the core also has
a lenticular shape,
a cushion shape,
a round shape,
an ellipsoid shape,
a rectangular shape or
a combination thereof.

11. The method according to claim 1, wherein the core consists of a material which is removable after heating.

12. The method according to claim 1, wherein the core consists of a material which contains chalk.

13. The method according to claim 1, wherein the core is flushed out after heating.

14. The method according to claim 1, wherein prior to application of the two-dimensional layers a pole cap is placed on the front side and/or the rear side of the core.

15. The method according to claim 14, wherein the fiber-reinforcing layer has an annular end portion which extends toward or is received by the pole caps.

16. An inflatable lifting cushion with main surfaces comprising a front side, a rear side and a peripheral region, wherein a distance of the front side to the rear side increases when the lifting cushion is inflated, the cushion comprising:
a two-dimensional layer of vulcanizable material on the front side,
a two-dimensional layer of vulcanizable material on the rear side,
a fiber-reinforcement of the vulcanizable material,
a single-layer or multi-layer two-dimensional fiber-reinforcing layer provided as a fiber reinforcement, said layer extending around an entire circumference of the peripheral region continuously without a separation point and covering the two-dimensional layers of vulcanizable material at least partially, and
fibers of the two-dimensional layer end in the region of the front side and/or the rear side.

17. The inflatable lifting cushion according to claim 16, wherein the fibers of the two-dimensional fiber-reinforcing layer extend into the front side and/or the back side around the peripheral region.

18. The inflatable lifting cushion according to claim 16, wherein the fiber-reinforcing layer forms overlap areas on the front side and/or the back side.

19. The inflatable lifting cushion according to claim 16, comprising at least one further two-dimensional layer of vulcanizable material on an outside of the fiber-reinforcing layer.

20. The inflatable lifting cushion according to claim 16, wherein the two-dimensional layers of vulcanizable material are round or rectangular.

21. The inflatable lifting cushion according to claim 16, wherein on the front side and/or the rear side, a pole cap is provided and the fiber-reinforcing layer comprises an annular end portion which extends to the pole cap or is received by the pole cap.

22. The inflatable lifting cushion according to claim 21, wherein the pole cap comprises a receptacle or step which receives respective end portions of the two-dimensional layers and/or of the fiber-reinforcing layer.
